(19) United States
(12) Patent Application Publication
(10) Pub. No.: US 2014/0212233 A1
(43) Pub. Date: Jul. 31, 2014

(54) CUTTING INSERT

(71) Applicants: Kwon Hee Park, Dalseong-gun, Daegu (KR); Dae Yeop Lee, Dalseong-gun, Daegu (KR)

(72) Inventors: Kwon Hee Park, Dalseong-gun, Daegu (KR); Dae Yeop Lee, Dalseong-gun, Daegu (KR)

(73) Assignee: TAEGUTEC, LTD., Dalseong-gun, Daegu (KR)

(21) Appl. No.: 14/342,271

(22) PCT Filed: Sep. 3, 2012
(86) PCT No.: PCT/KR2012/007045

§ 371 Date: Feb. 28, 2014

(30) Foreign Application Priority Data
Sep. 2, 2011 (KR) 10-2011-0089147

(51) Int. Cl. B23B 27/14; B23K 31/02

(52) U.S. Cl. CPC B23B 27/148; B23K 31/02
USPC 407/118; 228/121; 228/124.1

(57) ABSTRACT

A cutting insert has only cutting edge portion thereof made of SiC whisker reinforced ceramics brazed to the shank with active solder. This provides improved cutting performance by increased toughness and high strength of the SiC whisker reinforced ceramics without limitation in shape while reducing manufacturing costs. The cutting insert includes a cutting edge portion made of SiC whisker reinforced ceramics, and a shank to which the cutting edge portion is mounted. The cutting edge portion is brazed to the shank using an active solder, and the whiskers are disorderedly arranged and agglomerated in the cutting edge portion.

### TECHNICAL FIELD

The present invention generally relates to cutting inserts, and more particularly to a cutting insert in which only a cutting edge portion of the cutting insert is made of SiC whisker reinforced ceramics and brazed to the shank with active solder, thereby providing an improved cutting performance by increased toughness and high strength of the SiC whisker reinforced ceramics without limitation in shape while reducing manufacturing costs.

### BACKGROUND ART

Ceramic materials have mechanical characteristics suitable for high speed cutting due to their high wear resistance and high heat resistance. However, they have low fracture toughness due to the inherent brittleness of ceramics. To improve vulnerability, ceramic matrix composites in which whiskers are added to ceramic materials are widely used. SiC whisker reinforced ceramic, which is a representative ceramic matrix composite, is used in machining hard-to-cut materials such as Inconel, Waspaloy and Stellite due to its high toughness and high strength.

Generally, cutting inserts using SiC whisker reinforced ceramics are manufactured through forming sintered body by hot pressing ready-to-press powder and machining, e.g., a clamping hole in the cutting insert through laser cutting or grinding. Among these processes, hot pressing and laser cutting are unique processes required for manufacturing SiC whisker reinforced ceramic inserts.

First, in sintering SiC whisker reinforced ceramics, the hot pressing process is essential. SiC whisker reinforced ceramic is a very difficult material to obtain full density by a general powder metallurgy process. Thus, the hot pressing process is required for densification of the cutting insert.

However, the insert with a complicated geometrical shape cannot be manufactured through the hot pressing process since shape deformation of the materials occurs due to high temperature and high pressure. If the cutting insert to be processed has a complicated shape with a clamping hole, a dimple or a groove, then a separate machining process needs to be performed after the hot pressing is complete. In this case, the laser cutting with high cost is required since the SiC whisker reinforced ceramics have high hardness.

That is, it is problematic that the hot pressing process required for the SiC whisker reinforced ceramic insert limits the shape of the SiC whisker reinforced ceramic insert. Further, it is hard to machine the SiC whisker reinforced ceramic insert even in case of machining through a laser device due to its high hardness.

Further, since the laser cutting process needs to be performed to form such as a clamping hole, the manufacturing costs inevitably increase.

### DISCLOSURE OF INVENTION

The present invention has been made to address the above problems. Thus, it is the object of the present invention to provide a cutting insert having a complicated geometrical shape such as a clamping hole in manufacturing a cutting insert using SiC whisker reinforced ceramics.

It is another object of the present invention to provide a cutting insert, which can reduce the excessive manufacturing costs by performing, for example, expensive laser cutting for a clamping hole.

A cutting insert according to the present invention includes a cutting edge portion made of SiC whisker reinforced ceramics, and a shank made of cemented carbide, cermet or ceramics and to which the cutting edge portion is mounted. The cutting edge portion is brazed to the shank using an active solder, and the whiskers are disorderedly arranged and agglomerated in the cutting edge portion.

The SiC whisker reinforced ceramics may include 1.0 to 40 wt % of SiC whisker, not more than 30 wt % (including 0 wt %) of metal oxide selected from the group consisting of MgO, ZrO₂ and Y₂O₃, and 30 to 99 wt % of Al₂O₃, or 1.0 to 40 wt % of SiC whisker, not more than 80 wt % (including 0 wt %) of Al₂O₃, and not more than 99 wt % (including 0 wt %) of metal compound selected from the group consisting of metal carbide, metal carbonitride, metal nitride and metal boride.

The active solder may be made from Ag, Cu and Ti so as to include 0.5 to 20 wt % of Ti, 40 to 80 wt % of Ag, and not more than 40 wt % (including 0 wt %) of Cu, or made of Cu, Ni, Ti and Zr so as to include 10 to 40 wt % of Ti, 10 to 40 wt % of Zr, 10 to 30 wt % of Cu, and not more than 20 wt % (including 0 wt %) of Ni.

According to the present invention, there is provided a cutting insert whose shank is formed as a complicated shape with, for example, a clamping hole, a dimple, or a groove and only cutting edge portion is made of SiC whisker reinforced ceramics such that various geometrical structures are employed without limitation in shape and high cutting performance is realized due to high strength and toughness of the SiC whisker reinforced ceramics.

Since only the cutting edge portion contributing to machining is made of the SiC whisker reinforced ceramics and is brazed to the shank, the expensive SiC whisker reinforced ceramic materials in manufacturing the cutting insert can be saved.

Further, since expensive processes such as laser cutting and grinding to form, for example, a clamping hole in the SiC whisker reinforced ceramics are not required, the manufacturing costs of the cutting insert can be reduced.

The SiC whisker comprising the cutting edge portion is not arranged in a certain direction, but rather arranged disorderedly and agglomerated, thereby contributing to uniform improvement in breaking strength in every direction.

### BRIEF DESCRIPTION OF DRAWINGS

FIG. 1a is a plan view and FIG. 1b is a front view of a cutting insert according to one embodiment of the present invention.

FIG. 2 is an enlarged view of spheroidized SiC whisker reinforced ceramic mixed powder.

FIG. 3 is an enlarged view of polished surface texture of sintered body.

FIG. 4 is an enlarged view showing distribution of SiC whisker in the matrix.

FIG. 5 is an enlarged view of a boundary surface of welding zone between a cutting edge portion and a shank.

### BEST MODE FOR CARRYING OUT THE INVENTION

One embodiment of a cutting insert 1 according to the present invention will be described in detail with reference to the accompanying drawings.

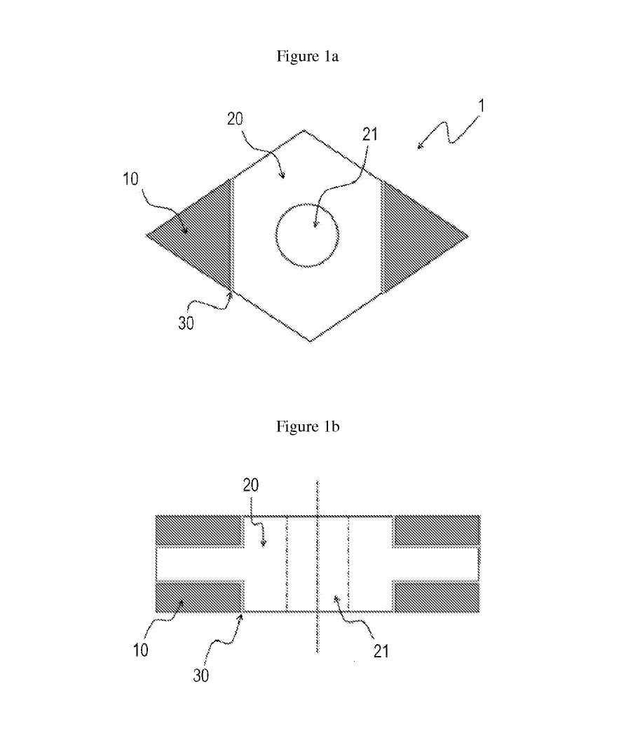

FIG. 1a shows a plan view and FIG. 1b shows a front view of a cutting insert according to one embodiment of the present invention. The cutting insert 1 includes a shank 20 with a clamping hole 21 and a cutting edge portion 10, which contributes to the machining of a workpiece.

The shank 20 constitutes a body of the cutting insert 1. Recesses whose number and shape correspond to those of the cutting edge portions 10 are formed at the end portion of the shank 20 such that the cutting edge portion 10 can be mounted. The shank 20 is provided with the clamping hole 21 for fastening the cutting insert 1 to a cutting tool. Since the shank 20 is made of cemented carbide, cermet or ceramics, the shank has no difficulty in machining thereof and can have any shape. Thus, the cutting insert can have any geometrical shape with such as a dimple or a groove as well as a clamping hole 21, provided that the shank 20 includes the portion having the complicated geometrical shape.

The cutting edge portion 10 is mounted at the corresponding recess formed at the shank 20 and positioned at the end portion of the cutting insert 1. The cutting edge portion 10 directly contacts the workpiece when machining. In this embodiment, it is exemplified that the cutting insert 1 has, but not limited to, four cutting edge portions 10. The cutting edge portion 10 may be mounted at all or part of the end portion of the cutting insert 1.

The cutting edge portion 10 is made of SiC whisker reinforced ceramics. The SiC whisker reinforced ceramics may include 1.0 to 40 wt % of SiC whisker, not more than 30 wt % (including 0 wt %) of metal oxide selected from the group consisting of MgO, ZrO₂ and Y₂O₃, and 30 to 99 wt % of Al₂O₃. The SiC whisker reinforced ceramics may include 1.0 to 40 wt % of SiC whisker, not more than 80 wt % (including 0 wt %) of Al₂O₃, and not more than 99 wt % (including 0 wt %) of metal compound selected from the group consisting of metal carbide, metal carbonitride, metal nitride and metal boride.

The manufacturing method of the cutting insert 1 containing the cutting edge portion 10 made of the SiC whisker reinforced ceramics is as follows.

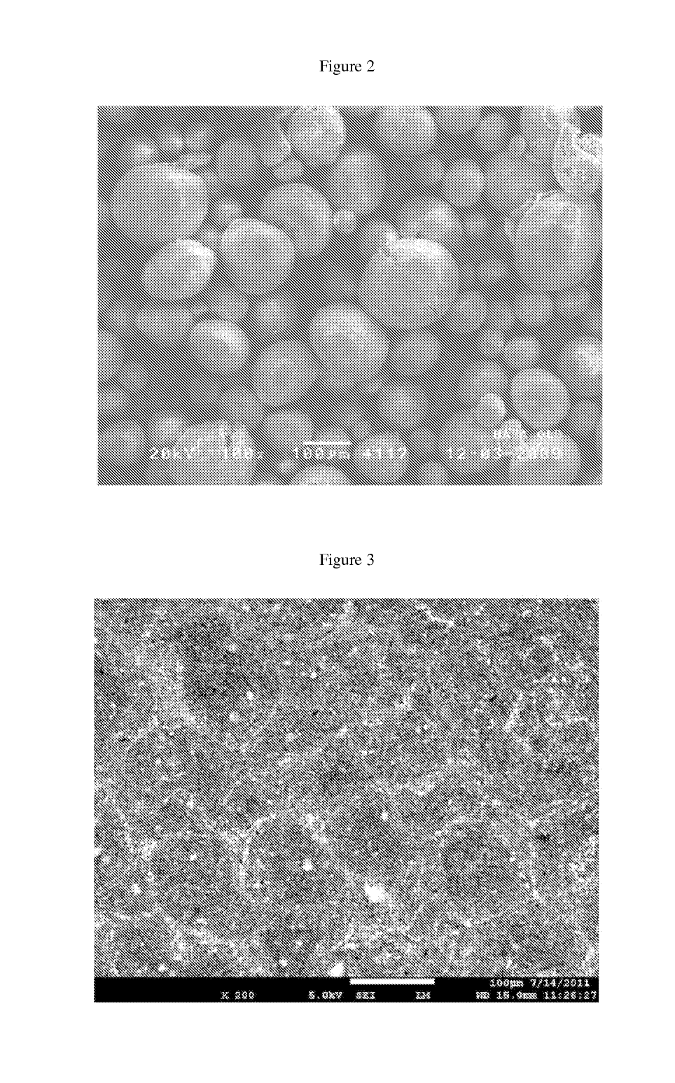

To manufacture the cutting edge portion 10, the mixed SiC whisker reinforced ceramic powder is spheroidized. Each of the SiC whisker reinforced ceramic powder is mixed to have the aforementioned composition. To mix the mixed powder uniformly, mixing or milling is performed in a dry or wet condition. The powder is mixed with volatile liquid such as ethyl alcohol, organic solvents, or water to be a mixture in slurry state. The mixture is sprayed through a nozzle by using spray dryer and heat is applied to evaporate the liquid component. When the liquid component is evaporated, the remaining solid component is agglomerated in round shape due to the characteristics that the surface area thereof is minimized. As a result, the spheroidized mixed powder shown in FIG. 2 is obtained. FIG. 2 is an enlarged view of spheroidized SiC whisker reinforced ceramic mixed powder seen with 100 times magnification.

By performing the spheroidizing process, filling density in moulding process is uniformized and sintered density increases due to the minimized internal air hole. Further, it is advantageous that when the spheroidized mixed powder is formed into a plate with large area, thickness variation is reduced due to the high liquidity thereof and sintered body with uniform density is obtained after sintering.

Thereafter, the spheroidized mixed powder is hot-pressed and sintered body is formed. As noted below, predetermined pressure is uniformly applied such that the SiC whiskers can be disorderedly arranged as possible in hot-pressing process. FIG. 3 is an enlarged view of polished surface texture of sintered body seen with 200 times magnification. It is observed that the shape of the sintered powder remains round and the particles are agglomerated, whereby the impact is relieved when the sintered body is used as a cutting tool and chipping resistance is improved.

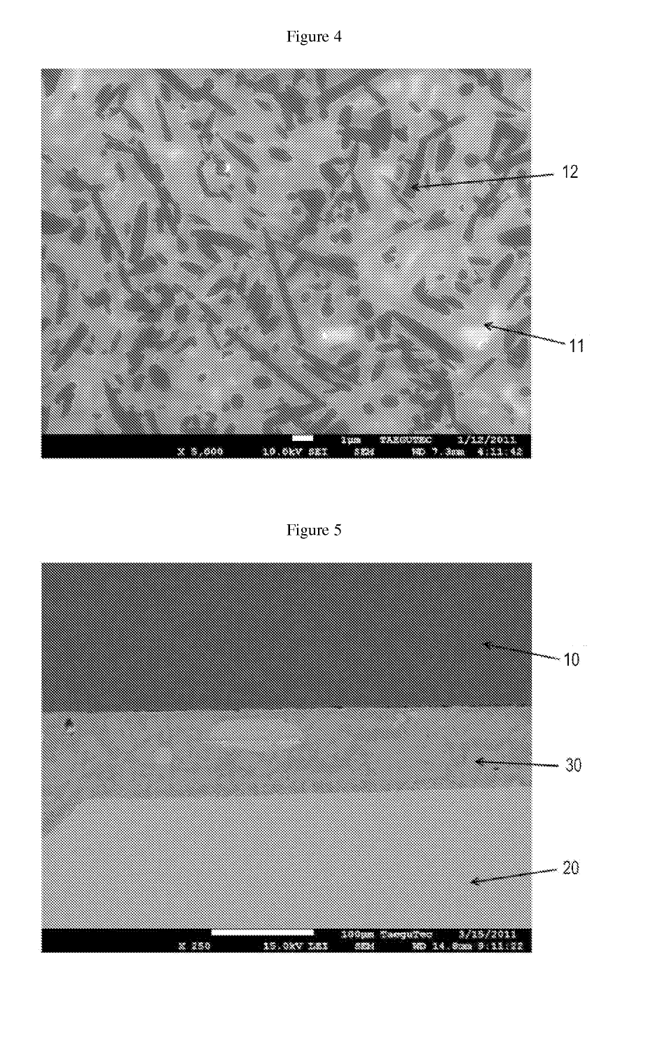

FIG. 4 is an enlarged view of the sintered body seen with high magnification of 5000 times. In the highly magnified image, the light gray area designates the Al₂O₃ matrix 11 and the dark gray area designates the SiC whiskers 12. As shown in the figure, the SiC whiskers 12 can have various lengths in the Al₂O₃ matrix 11. This is because the length of the SiC whiskers 12 is observed differently depending on orientation of the SiC whiskers 12. The ones with long length are oriented horizontally, while the ones with short length are oriented vertically. That is, the whiskers are not aligned along a certain direction but disorderedly arranged and agglomerated to thereby uniformly contribute to increase of braking strength in every direction.

When the cutting edge portion 10 and the shank 20 are manufactured, the cutting edge portion 10 is brazed to the corresponding recess of the shank 20. To prevent contamination, the brazing process is performed in an insert gas atmosphere such as Ar. Generally, ceramics and metal are hardly connected by welding due to low solid solubility and low coefficient of friction therebetween. In the cutting insert 1 according to this embodiment, the cutting edge portion 10, which is made of the SiC whisker reinforced ceramics, and the shank 20 that is made of the cemented carbide, cannot be connected with conventional solder. Thus, the brazing is performed using an active solder to connect the SiC whisker reinforced ceramics with high intensity. The active solder may comprise 0.5 to 20 wt % of Ti, 40 to 80 wt % of Ag, and not more than 40 wt % (including 0 wt %) of Cu, or 10 to 40 wt % of Ti, 10 to 40 wt % of Zr, 10 to 30 wt % of Cu, and not more than 20 wt % (including 0 wt %) of Ni. The brazing method using the above-mentioned active solder can be applied to the case that the shank 20 is made of cermet or ceramics. Thus, the shank 20 of the cutting insert 1 according to the present invention can be made of carbide, cermet or ceramics.

Referring to FIG. 5 showing a boundary surface of welding zone, the SiC whisker reinforced ceramics constituting the cutting edge portion 10 and the cemented carbide constituting the shank 20 are firmly connected to the active solder 30 intervening therebetween. According to the assessment result of cutting performance, no failure of the welding zone is observed and the cutting performance is better than that of a cutting tool without welding.

As described above, the cutting edge portion 10 is mounted at the very end portion of the cutting insert 1 and has nothing to do with the area having a complicated geometrical shape. In addition to machining the SiC whisker reinforced ceramics to be fit to the corresponding recess of the shank 20, there is no need to additionally machine the SiC whisker reinforced ceramics to form, for example, a clamping hole by using laser cutting or the like. Thus, the expense for laser cutting of the SiC whisker reinforced ceramics is reduced.

Further, since a desired geometrical shape can be embodied by the shank 20 and only the end portion of the cutting insert 1 which contributes to machining is made of the SiC whisker reinforced ceramics, the expensive SiC whisker reinforced ceramic materials in manufacturing the cutting insert can be saved and the manufacturing costs can be reduced.

1. A cutting insert, comprising:
a cutting edge portion made of SiC whisker reinforced ceramics; and
a shank to which the cutting edge portion is mounted,
wherein the cutting edge portion is brazed to the shank using an active solder; and
wherein the SiC whiskers are disorderedly arranged in the cutting edge portion.

2. The cutting insert of claim 1, wherein the SiC whisker reinforced ceramics comprises 1.0 to 40 wt % of SiC whisker, 30 to 99 wt % of Al₂O₃, and not more than 30 wt % (including 0 wt %) of metal oxide selected from the group consisting of MgO, ZrO₂ and Y₂O₃.

3. The cutting insert of claim 1, wherein the SiC whisker reinforced ceramics comprises 1.0 to 40 wt % of SiC whisker, not more than 80 wt % (including 0 wt %) of Al₂O₃, and not more than 99 wt % (including 0 wt %) of metal compound selected from the group consisting of metal carbide, metal carbonitride, metal nitride and metal boride.

4. The cutting insert of claim 1, wherein the active solder comprises 0.5 to 20 wt % of Ti, 40 to 80 wt % of Ag, and not more than 40 wt % (including 0 wt %) of Cu.

5. The cutting insert of claim 1, wherein the active solder comprises 10 to 40 wt % of Ti, 10 to 40 wt % of Zr, 10 to 30 wt % of Cu, and not more than 20 wt % (including 0 wt %) of Ni.

6. The cutting insert of claim 1, wherein the shank is made of cemented carbide, cermet or ceramics.

7. A method of manufacturing a cutting insert, comprising:
mixing SiC whisker reinforced ceramic powder uniformly;
spheroidizing the mixed SiC whisker reinforced ceramic powder by spray drying;
hot-pressing the spheroidized SiC whisker reinforced ceramic powder to be sintered to form a cutting edge portion comprising SiC whiskers disorderedly arranged therein; and
brazing the cutting edge portion to a shank made of cemented carbide using an active solder.

8. The cutting insert of claim 2, wherein the SiC whisker reinforced ceramics comprises at least some of said metal oxide selected from the group consisting of MgO, ZrO₂ and Y₂O₃.

9. The cutting insert of claim 3, wherein the SiC whisker reinforced ceramics comprises at least some of said Al₂O₃, and at least some of said metal compound selected from the group consisting of metal carbide, metal carbonitride, metal nitride and metal boride.

10. The cutting insert of claim 4, wherein the active solder comprises at least some of said Cu.

11. The cutting insert of claim 5, wherein the active solder comprises at least some of said Ni.

12. A ceramic-tipped cutting insert, comprising:
a cutting edge portion made of SiC whisker reinforced ceramics comprising 1.0 to 40 wt% of SiC whiskers; and
a shank to which the cutting edge portion is mounted,
wherein the cutting edge portion is brazed to the shank using an active solder; and
wherein the SiC whiskers are randomly oriented in a ceramic matrix comprising Al₂O₃.

13. The ceramic-tipped cutting insert of claim 12, wherein the SiC whisker reinforced ceramics comprises 30 to 99 wt % of Al₂O₃, and at least some metal oxide selected from the group consisting of MgO, ZrO₂ and Y₂O₃.

14. The ceramic-tipped cutting insert of claim 12, wherein the SiC whisker reinforced ceramics comprises not more than 80 wt % of Al₂O₃, and at least some metal compound selected from the group consisting of metal carbide, metal carbonitride, metal nitride and metal boride.

15. The ceramic-tipped cutting insert of claim 12, wherein the active solder comprises 0.5 to 20 wt % of Ti, 40 to 80 wt % of Ag, and not more than 40 wt % of Cu.

16. The ceramic-tipped cutting insert of claim 12, wherein the active solder comprises 10 to 40 wt % of Ti, 10 to 40 wt % of Zr, 10 to 30 wt % of Cu, and not more than 20 wt % of Ni.

17. The ceramic-tipped cutting insert of claim 12, wherein the shank is made of cemented carbide, cermet or ceramics.

18. A method of manufacturing the ceramic-tipped cutting insert of claim 12, comprising:
mixing SiC whisker reinforced ceramic powder uniformly, the ceramic powder including Al₂O₃;
spheroidizing the mixed SiC whisker reinforced ceramic powder by spray drying;
hot-pressing the spheroidized SiC whisker reinforced ceramic powder to be sintered to form a cutting edge portion comprising SiC whiskers randomly oriented in a ceramic matrix comprising Al₂O₃; and
brazing the cutting edge portion to a shank using an active solder.
